(19) United States
(12) Patent Application Publication
(10) Pub. No.: US 2025/0004901 A1
(43) Pub. Date: Jan. 2, 2025

(54) SUCCESSOR SETTING SYSTEM, SUCCESSOR SETTING METHOD, AND PROGRAM

(71) Applicant: Hitachi, Ltd., Tokyo (JP)

(72) Inventors: Kosaku IZUMI, Tokyo (JP); Yuusuke ASAI, Tokyo (JP); Hiroshi HAYAKAWA, Tokyo (JP)

(21) Appl. No.: 18/591,073

(22) Filed: Feb. 29, 2024

(30) Foreign Application Priority Data
Jun. 28, 2023 (JP) 2023-105857

(51) Int. Cl. G06F 11/34

(52) U.S. Cl. CPC G06F 11/3438

(57) ABSTRACT

To provide a successor setting system that can set a successor without setting the successor in advance even when an administrator of IT infrastructure management information is absent without taking over. A successor setting system includes: a successor selection rule management table in which a successor selection rule is managed, the successor selection rule being used to select a successor of an administrator of IT infrastructure management information by which a resource and users who operate the resource are managed when the administrator is unable to continue managing the IT infrastructure management information; and an activity history monitoring unit that monitors activity history of the users in the resource, applies an evaluation result obtained by evaluating the activity history for each user to the successor selection rule to select the user who is to be the successor, and sets the selected user as the successor.

### CROSS-REFERENCE TO RELATED APPLICATION

The present application claims priority from Japanese application JP2023-105857, filed on Jun. 28, 2023, the content of which is hereby incorporated by reference into this application.

### BACKGROUND OF THE INVENTION

### 1. Field of the Invention

The present invention relates to a successor setting system, a successor setting method, and a program.

### 2. Description of Related Art

For management information on an information technology (IT) infrastructure (abbreviated as IT infrastructure management information) that is used in, for example, a storage management service, software development management service, or the like and that manages a resource, a user who operates the resource, and an authority for the user to operate the resource, a privileged user who manages the IT infrastructure management information (hereinafter, referred to as an “administrator”) exists. In the related art, due to a reason such as an unexpected situation occurring to an administrator, the administrator may be absent with no successor taking over work. Assuming such a situation, there is a method in which the administrator sets the successor in advance in order to continuously use the IT infrastructure management information.

PTL 1 discloses that “when an operating state of a system administrator selected from a plurality of users using services provided by a system satisfies a preset condition, login as a proxy of the system administrator by another preset user is permitted, and an authority to appoint a new system administrator is granted to the other user who is permitted to log in”.

### CITATION LIST

### Patent Literature

PTL 1: JP2022-150815A

### SUMMARY OF THE INVENTION

In the technique disclosed in PTL 1, the other user other than the administrator needs to be preset as the successor. However, in a case of an organization where a structure for managing the IT infrastructure management information is frequently changed or where a management structure of the IT infrastructure management information is chronically understaffed, it is difficult to set an appropriate successor in advance. Therefore, a mechanism is required in which the IT infrastructure management information can be continuously used without setting the successor in advance even when the administrator is absent without taking over.

The invention has been made in view of such a situation, and an object thereof is to select and set a successor who can continue management of IT infrastructure management information without setting the successor in advance.

A successor setting system according to the invention includes: a successor selection rule management table in which a successor selection rule is managed, the successor selection rule being used to select a successor of an administrator of infrastructure management information by which users who operate a resource are managed when the administrator is unable to continue managing the infrastructure management information; and an activity history monitoring unit configured to monitor activity history of the users in the resource, apply an evaluation result obtained by evaluating the activity history for each user to the successor selection rule to select the user who is to be the successor, and set the user as the successor.

According to the invention, even without setting a successor in advance, it is possible to select a user to be a successor who can continue management of infrastructure management information and set the selected user as the successor.

Problems, configurations, and effects other than those described above will be made clear by the following description of the embodiment.

### BRIEF DESCRIPTION OF THE DRAWINGS

FIG. 1 is a block diagram showing overall configuration examples of an IT infrastructure management information providing system and a successor setting system according to an embodiment of the invention;

FIG. 2 is a block diagram showing an internal configuration example of the successor setting system according to the embodiment of the invention;

FIG. 3 is a diagram showing configuration examples of an IT infrastructure management information management table and a user information management table according to the embodiment of the invention;

FIG. 4 is a diagram showing configuration examples of a role information management table and a user belonging information management table according to the embodiment of the invention;

FIG. 5 is a diagram showing configuration examples of a ranking management table and a schedule management table according to the embodiment of the invention;

FIG. 6 is a diagram showing a configuration example of a successor selection rule management table according to the embodiment of the invention;

FIG. 7 is a diagram showing configuration examples of an activity history evaluation method management table and an activity history acquisition method management table according to the embodiment of the invention;

FIG. 8 is a diagram showing configuration examples of an activity history acquisition program storage location management table and an activity history evaluation program storage location management table according to the embodiment of the invention;

FIG. 9 is a diagram showing configuration examples of a score management table and an action program storage location management table according to the embodiment of the invention;

FIG. 10 is a diagram showing configuration examples of an administrator absence determination rule management table, an administrator absence determination method management table, and an administrator absence determination program storage location management table according to the embodiment of the invention;

FIG. 11 is a flowchart showing an example of activity history monitoring processing performed by an activity history monitoring unit of the successor setting system according to the embodiment of the invention;

FIG. 12 is a flowchart an showing example of administrator absence determination processing according to the embodiment of the invention;

FIG. 13 is a flowchart showing an example of processing of acquiring and storing activity history by an activity history processing unit according to the embodiment of the invention;

FIG. 14 is a flowchart showing an example of processing of specifying, by a user specifying unit, a user to be evaluated by a user evaluation unit according to the embodiment of the invention;

FIG. 15 is a flowchart showing an example of processing of evaluating, by the user evaluation unit, the user specified by the user specifying unit according to the embodiment of the invention;

FIG. 16 is a flowchart showing an example of processing of executing an action program by an action program execution unit according to the embodiment of the invention;

FIG. 17 is a flowchart showing an example of processing of monitoring a schedule of successor selection and changing a role of the user by the schedule monitoring unit according to the embodiment of the invention;

FIG. 18 is a flowchart showing an example of successor selection rule upload processing according to the embodiment of the invention;

FIG. 19 is a flowchart showing an example of ranking acquisition processing according to the embodiment of the invention; and

FIG. 20 is a block diagram showing a hardware configuration example of a computer according to the embodiment of the invention.

### DESCRIPTION OF EMBODIMENTS

Hereinafter, embodiments for carrying out the invention will be described with reference to the accompanying drawings. In the present specification and the drawings, elements having substantially the same functions or configurations are denoted by the same reference numerals, and repeated description will be omitted.

### Embodiment

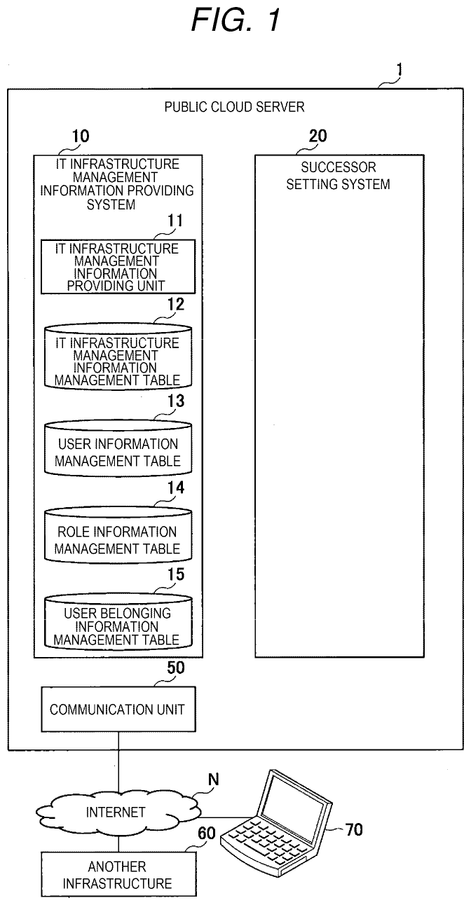

FIG. 1 is a block diagram showing overall configuration examples of an IT infrastructure management information providing system 10 and a successor setting system 20 according to an embodiment of the invention.

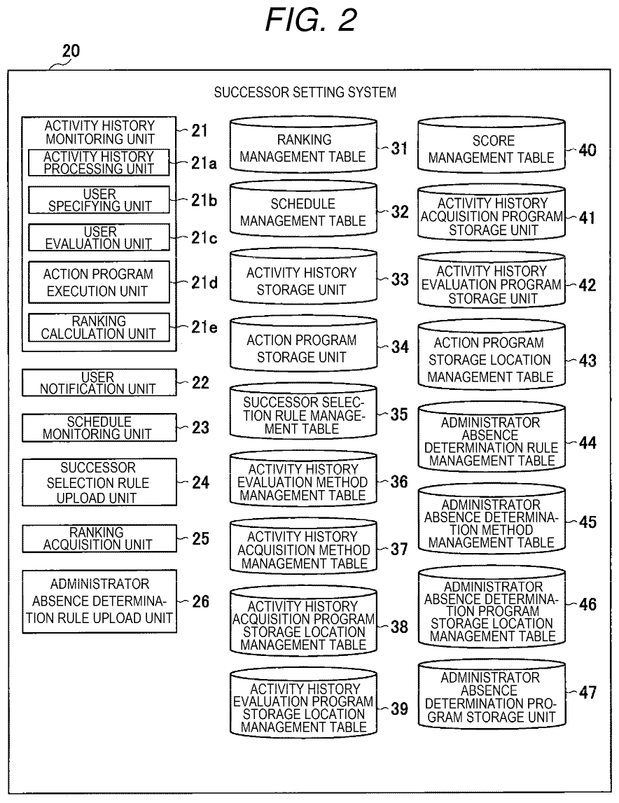

FIG. 2 is a block diagram showing an internal configuration example of the successor setting system 20 according to the embodiment of the invention. In the following description, functions of units and contents of a table will be described with reference to a configuration diagram of the table as appropriate.

The IT infrastructure management information providing system 10 and the successor setting system 20 can be applied to, for example, a multi-tenant system that manages storages of a plurality of customers (tenants) by one system, and a management system of a resource (a storage, customer information, and the like) that is an asset other than a user. IT infrastructure management information is information by which a user who operates a resource is managed. The IT infrastructure management information may be information by which a resource, a user who operates the resource, and an authority for the user to operate the resource are managed.

The public cloud server 1 can communicate with another infrastructure 60 via an internet N. A PC 70 that can be used by a user different from the user who uses the IT infrastructure management information is connected to the public cloud server 1 via the internet N. The PC 70 can access the public cloud server 1 and upload a successor selection rule. Further, the PC 70 can also access the public cloud server 1 and upload an administrator absence determination rule. The PC 70 may be used by an administrator or a third party other than the administrator.

The public cloud server 1 includes the IT infrastructure management information providing system 10, the successor setting system 20, and a communication unit 50.

First, the IT infrastructure management information providing system 10 will be described. The IT infrastructure management information providing system 10 has a function of providing the user with a function related to the IT infrastructure management information described above. The IT infrastructure management information providing system 10 includes an IT infrastructure management information providing unit 11, an IT infrastructure management information management table 12, a user information management table 13, a role information management table 14, and a user belonging information management table 15.

The IT infrastructure management information providing unit 11 has a function of managing a resource used by a user who accesses the public cloud server 1. Therefore, the IT infrastructure management information providing unit 11 has a function of managing a user that uses the other infrastructure 60 and a resource as the IT infrastructure management information and providing the administrator with the IT infrastructure management information. Therefore, the user can use the resource managed by the IT infrastructure management information.

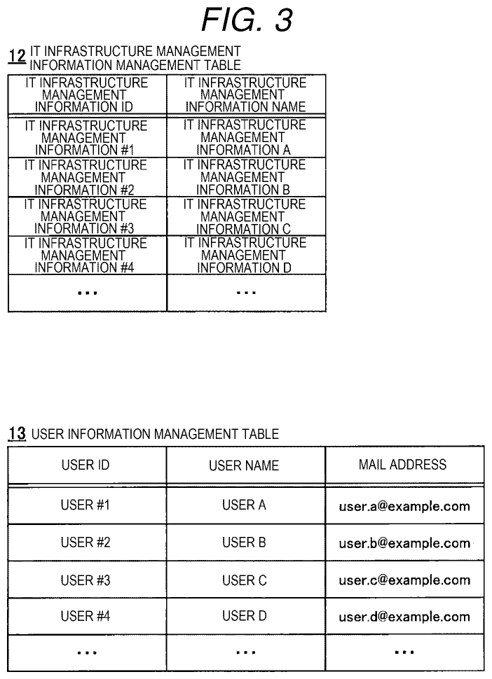

FIG. 3 is a diagram showing configuration examples of the IT infrastructure management information management table 12 and the user information management table 13.

The IT infrastructure management information management table 12 is a table for managing an IT infrastructure management information name for each IT infrastructure management information. In the IT infrastructure management information management table 12, an IT infrastructure management information ID assigned to each piece of IT infrastructure management information is provided, and the IT infrastructure management information name such as IT infrastructure management information A, B, or the like is set for each IT infrastructure management information ID.

The user information management table 13 is a table for managing user information of a user who uses the IT infrastructure management information. The user information management table 13 is assigned to each user, and is provided with a user ID by which a user is identified. A user name such as user A, B, or the like is set for each user ID. Further, a mail address used by the user is set for each user ID.

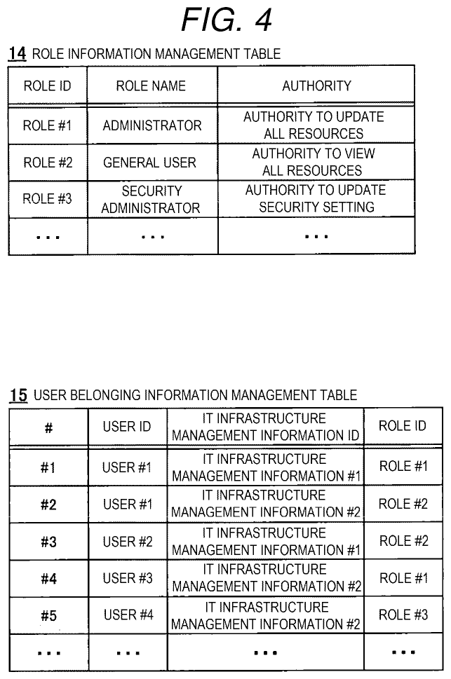

FIG. 4 is a diagram showing configuration examples of the role information management table 14 and the user belonging information management table 15.

The role information management table 14 is a table for managing an authority for each role as role information. The role is a set of authorities assigned to the user. The role information management table 14 is provided with a role ID assigned to each role, and stores a role name and an authority for each role ID. The role name is represented by a name, for example, an administrator, a general user, or a security administrator. It is shown that when the role name is the administrator, the authority is updating all resources, when the role name is the general user, the authority is viewing all the resources, and when the role name is the security administrator, the authority is updating a security setting.

The user belonging information management table 15 is a table for managing information on which IT infrastructure management information the user belongs to and a role in the IT infrastructure management information. The user belonging information management table 15 stores the user ID, an IT infrastructure management information ID, and a role ID. For example, a user as user #1 is the administrator (role #1) in IT infrastructure management information #1, and is the general user (role #2) in IT infrastructure management information #2. Further, a user as user #3 is the administrator (role #1) in IT infrastructure management information #2. In this way, a user belonging to certain IT infrastructure management information and a role of the user are managed by the user belonging information management table 15. In the user belonging information management table 15, even when a plurality of administrators are set for one piece of the IT infrastructure management information, if one administrator is absent, another administrator is not automatically selected as a successor. Even in such a case, an evaluation for activity history of the user and a ranking of an evaluation result of the user are calculated based on a definition of a successor selection rule management table 35, and a next successor is selected.

Next, returning to FIG. 2, the successor setting system 20 will be described. The successor setting system 20 has a function for automatically setting a successor of a system in which the administrator is absent under a predetermined condition. Here, functions of the successor setting system 20 will be described separately into an operation unit and a storage unit.

The successor setting system 20 includes, as functional units, an activity history monitoring unit 21, a user notification unit 22, a schedule monitoring unit 23, a successor selection rule upload unit 24, a ranking acquisition unit 25, and an administrator absence determination rule upload unit 26. The functional units of the successor setting system 20 may be executed in any order.

The activity history monitoring unit 21 is activated by periodic automatic execution or manual execution of the user, and has a function of monitoring activity history of the user of the resource. Further, the activity history monitoring unit 21 has a function of applying an evaluation result obtained by evaluating activity history for each user to the successor selection rule management table 35 to select a user to be the successor, and setting the selected user as the successor.

Therefore, the activity history monitoring unit 21 acquires activity history of each of users from the other infrastructure 60 based on information stored in the successor selection rule management table 35, and stores the activity history in an activity history storage unit 33. The activity history is acquired by an activity history acquisition program to be described later. The activity history acquired by the activity history monitoring unit 21 is information that can be acquired from the other infrastructure 60 by the public cloud server 1. Further, the activity history monitoring unit 21 evaluates (scores) each user based on the activity history, and calculates a ranking of an evaluation result evaluated by an activity history evaluation program for the activity history acquired for each user by the activity history acquisition program. Thereafter, the activity history monitoring unit 21 stores a score and a ranking in a ranking management table 31. The activity history is evaluated by an activity history evaluation program to be described later. Further, the activity history monitoring unit 21 executes a countermeasure action such as setting a user having a first ranking as the successor.

The countermeasure action is processing corresponding to an action program, and is stored in an action program storage location management table 43. The countermeasure action has various types. For example, as the countermeasure action, there is processing of granting an authority to an appropriate user. Further, as the countermeasure action, there is processing of downgrading an authority of a previous administrator to the general user. Further, as the countermeasure action, there is processing of notifying a user who is set as the successor that the user has been set as the successor. Further, as the countermeasure action, there is processing of notifying a warning urging a review of the successor selection rule when a user corresponding to the ranking is absent. Further, as the countermeasure action, there is processing of registering a successor setting event to a scheduler.

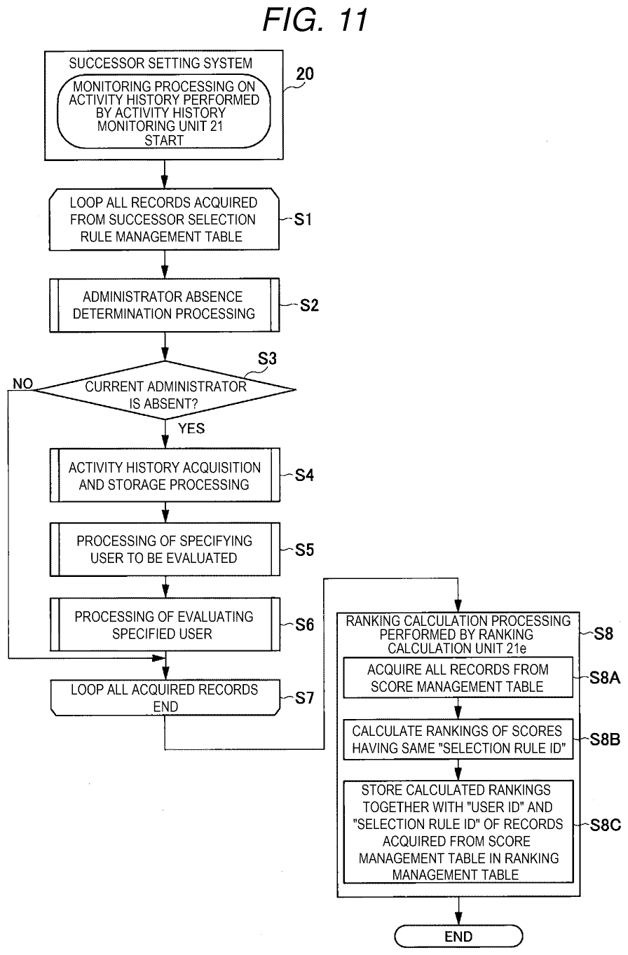

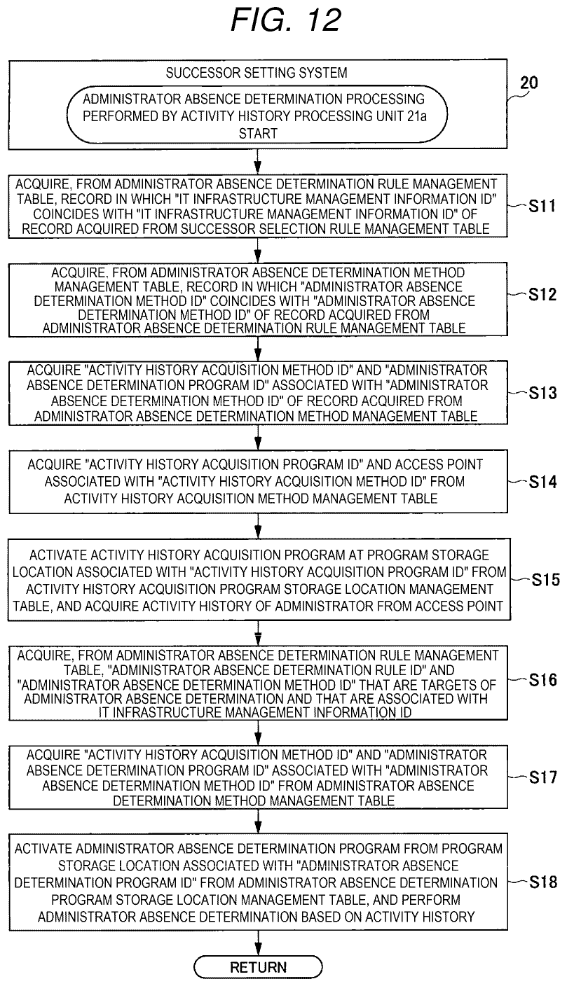

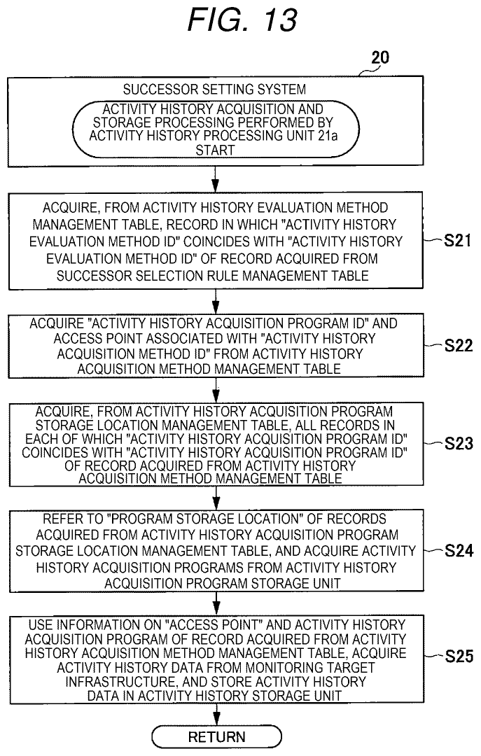

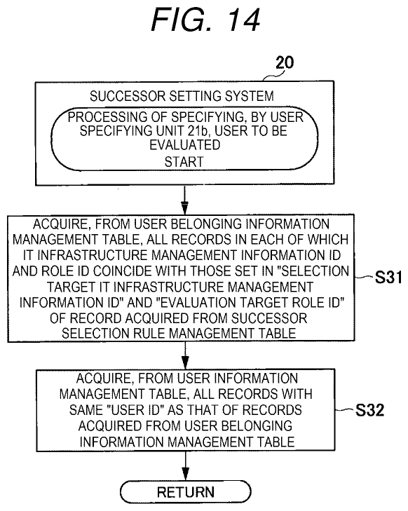

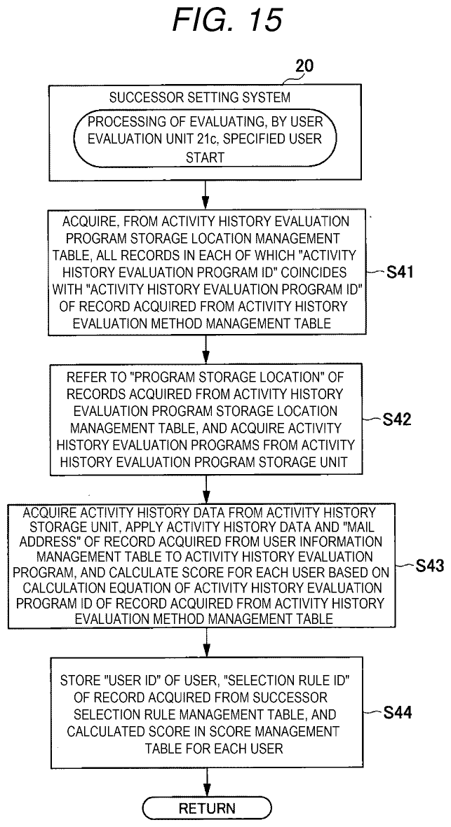

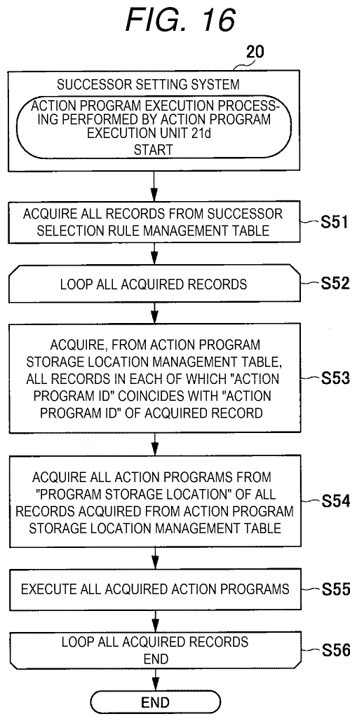

The activity history monitoring unit 21 includes an activity history processing unit 21a, a user specifying unit 21b, a user evaluation unit 21c, an action program execution unit 21d, and a ranking calculation unit 21e. The activity history processing unit 21a performs administrator absence determination processing shown in FIG. 12 to be described later. Further, the activity history processing unit 21a performs acquisition and storage processing of the activity history shown in FIG. 13 to be described later. The user specifying unit 21b performs processing of specifying a user to be evaluated by the user evaluation unit 21c shown in FIG. 14 to be described later. The user evaluation unit 21c performs processing of evaluating the user specified by the user specifying unit 21b shown in FIG. 15 to be described later. The action program execution unit 21d performs execution processing of the action program shown in FIG. 16 to be described later. The ranking calculation unit 21e performs ranking calculation processing shown in FIG. 11 to be described later.

The user notification unit 22 is activated by the countermeasure action, and notifies a user selected as the successor that the user has been selected as the successor. For example, when the notification is displayed on a screen of the PC 70, or is sent by email to the user selected as the successor, the user can confirm notification contents. When the user is notified that he or she has been selected as the successor, the user himself or herself manually sets himself or herself as the successor. A third party other than the user selected as the successor may set the selected user as the successor.

The schedule monitoring unit 23 is activated by periodic automatic execution or manual execution, and has a function of changing a role of the user according to a schedule management table 32. When current date and time exceeds schedule date and time in a record in the schedule management table 32, the schedule monitoring unit 23 changes a role according to the record.

The successor selection rule upload unit 24 is activated by the manual execution, updates a table or a storage unit related to the selection rule such as the successor selection rule management table 35, and changes the successor selection rule. The successor selection rule upload unit 24 writes data uploaded from the PC 70 used by the user into the successor selection rule management table 35 via the internet N.

The ranking acquisition unit 25 is activated by the manual execution of the user, and acquires a result of a ranking from the ranking management table 31. When an administrator role ID is designated as an evaluation target role ID in the successor selection rule management table 35, the administrator also becomes a target of the user evaluation and the ranking.

The PC 70 used by the third party or an API of a server (not shown) may request the public cloud server 1 to acquire a ranking. In this case, the ranking acquisition unit 25 outputs a result of the ranking to another system or device that issues an instruction to acquire the result of the ranking. For example, the ranking acquisition unit 25 is activated by the API, and acquires the rankings of the users in certain IT infrastructure management information to provide the PC 70 or the API of the server with a ranking of each user. Therefore, the third party can acquire a ranking more flexibly and use the ranking.

A reason why the ranking acquisition unit 25 is activated by the manual execution is that a use case is assumed in which the third party other than the administrator or the user uses a ranking for a purpose different from selecting the successor. When the ranking acquisition unit 25 is executed manually, the third party can acquire the ranking at any timing. For example, the following cases are assumed.
(1) In a personnel evaluation, rankings of users are acquired.
(2) Even when the administrator is temporarily absent, if a user of the IT infrastructure management information providing system 10 wants to make a support inquiry or the like, in order to be able to contact a person responsible for the IT infrastructure management information immediately, a user on behalf of the administrator is listed as a contact information.

The administrator absence determination rule upload unit 26 is activated by the manual execution of the user, updates tables and storage units related to the administrator absence determination rule such as an administrator absence determination rule management table 44, an administrator absence determination method management table 45, an administrator absence determination program storage location management table 46, and an administrator absence determination program storage unit 47, and changes the administrator absence determination rule. For example, the administrator absence determination rule upload unit 26 writes data uploaded from the PC 70 used by the user into the administrator absence determination rule management table 44 via the internet N.

The successor setting system 20 includes, as storage units, the ranking management table 31, the schedule management table 32, the activity history storage unit 33, an action program storage unit 34, the successor selection rule management table 35, an activity history evaluation method management table 36, an activity history acquisition method management table 37, an activity history acquisition program storage location management table 38, an activity history evaluation program storage location management table 39, a score management table 40, an activity history acquisition program storage unit 41, an activity history evaluation program storage unit 42, the action program storage location management table 43, the administrator absence determination rule management table 44, the administrator absence determination method management table 45, the administrator absence determination program storage location management table 46, and the administrator absence determination program storage unit 47.

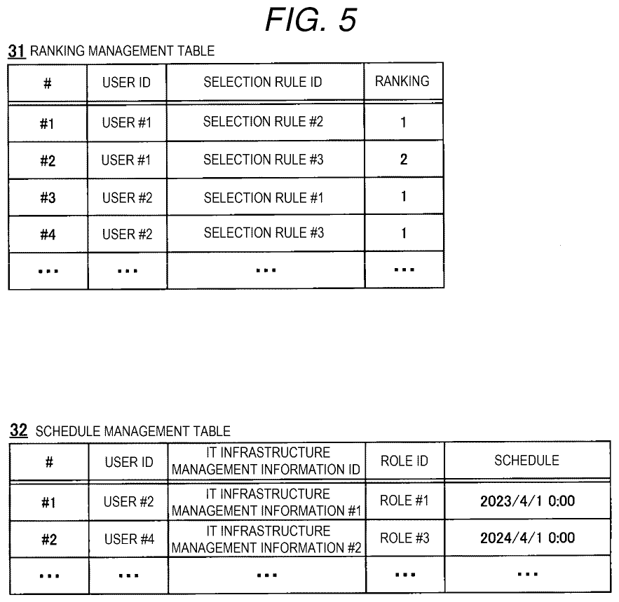

FIG. 5 is a diagram showing configuration examples of the ranking management table 31 and the schedule management table 32.

The ranking management table 31 is a table for managing the rankings of the users. The ranking management table 31 stores the user ID, a selection rule ID, and the ranking. The selection rule ID is set for a selection rule of the successor. The ranking is an index referred to for selecting a successor in a certain selection rule. The schedule monitoring unit 23 selects a user whose result of a ranking acquired by the ranking acquisition unit 25 is high as the successor, and sets the user as the successor according to an instruction of the user selected as the successor. In a case of the same selection rule ID, a user whose ranking is high (for example, the ranking is “1”) is selected as the successor first. When the user selected as the successor declines the role of administrator, a user having a next ranking (for example, the ranking is “2”) is selected as the successor.

The schedule management table 32 is a table for managing a schedule for selecting the successor. The schedule management table 32 stores the user ID, the IT infrastructure management information ID, the role ID, and a schedule. In the schedule, date and time for selecting a successor are set. When current date and time reach date and time set in the schedule, successor selection processing is activated, and a successor is selected. Therefore, an existing role of a user shown in the user belonging information management table 15 in FIG. 4 and a role shown in the schedule management table 32 have no relation. For example, as shown in the user belonging information management table 15, a current administrator (role #1) is the user as user #1 in the IT infrastructure management information #1. However, a user as user #2 whose ranking is first is selected as an administrator (role #1) in the IT infrastructure management information #1 in a next schedule.

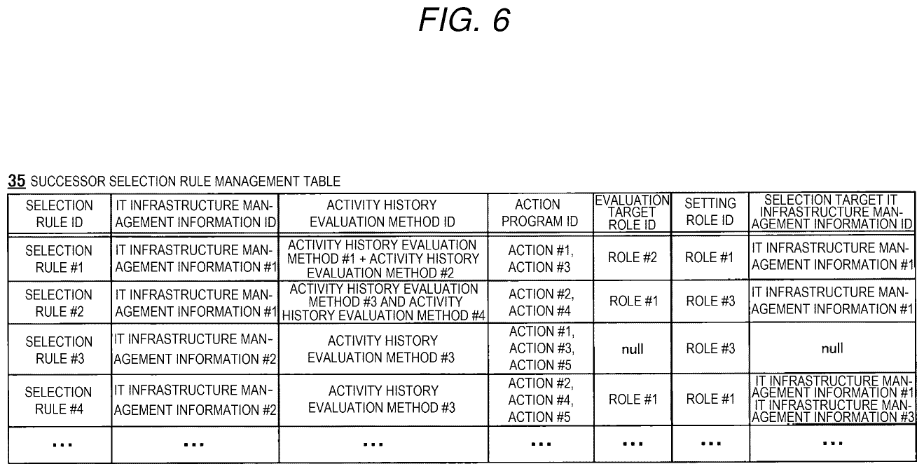

The role ID of IT infrastructure management information #2 in the schedule management table 32 stores a role #3.The reason is that in a selection rule #3 in the successor selection rule management table 35 shown in FIG. 6 to be described later, the role #3 is stored in the role ID set for the user having the first ranking. However, when a user as user #4 has the first ranking, the user #4 may be selected as an administrator (role #1) in the IT infrastructure management information #2. In this case, a role ID #1 is set in a setting role ID of the selection rule #3 in the successor selection rule management table 35. In contrast, in a case where the user #4 does not have the first ranking, when an action program for demoting the administrator is created, the role #2 may be stored in the role ID in the schedule management table 32.

The activity history storage unit 33 is a storage unit that stores activity history data of the users who are monitoring targets. The activity history data is stored in the activity history storage unit 33 as raw data, and is not managed as a table, and therefore a configuration diagram of the activity history storage unit 33 is not shown.

The action program storage unit 34 is a storage unit that stores the action program that executes an action on a ranking. Since the action program is a program itself stored in a storage region of the successor setting system 20, a configuration diagram of the action program storage unit 34 is not shown.

FIG. 6 is a table showing a configuration example of the successor selection rule management table 35.

The successor selection rule management table 35 is a table for managing the successor selection rule used to select the successor of the administrator when the administrator of the IT infrastructure management information cannot continue management of the IT infrastructure management information. In the successor selection rule management table 35, an evaluation method for the activity history and processing performed on a corresponding user by the evaluation method for the activity history are defined for each piece of IT infrastructure management information and for each role in which an authority for a user to operate a resource is defined. For example, the successor selection rule management table 35 stores the selection rule ID, the IT infrastructure management information ID, an activity history evaluation method ID, an action program ID, the evaluation target role ID, the setting role ID, and a selection target IT infrastructure management information ID. The selection rule ID is the same as that in the ranking management table 31.

The activity history evaluation method ID defines the evaluation method for the activity history of the user for each selection rule. A plurality of evaluation results are calculated by a combination of four arithmetic operation symbols (+, −, *, /) or logical operation symbols (AND, OR, NOT) defined in the activity history evaluation method ID in the successor selection rule management table 35. When an evaluation result is a score, the four arithmetic operations are used. For example, in the selection rule #1, scores calculated by activity history evaluation methods #1 and #2 are added.

When an evaluation result is a true or false value, the logical operation is used. For example, in a selection rule #2, a result of an AND condition for a true or false result calculated by activity history evaluation methods #3 and #4 is obtained. Here, an activity history evaluation program #3 defined in the activity history evaluation method #3 evaluates a score of the activity history. An activity history evaluation program #4 defined in the activity history evaluation method #4 evaluates whether the number of years of service of a user is five years or more. Therefore, for example, when the user is determined to have five or more years of service by an activity history acquisition program #4, the score of the activity history evaluated by the activity history evaluation program #3 is an evaluation target. In contrast, a score of a user determined to have less than five years of service by the activity history acquisition program #4 is not the evaluation target.

The action program ID in the successor selection rule management table 35 defines an action when selecting a user as the successor. The action program includes processing of promoting the general user to the administrator, and processing of demoting the administrator to the general user. In FIG. 6, the action program is abbreviated as an “action”. The evaluation target role ID defines a role of a user that is an evaluation target for evaluating the activity history. For example, the administrator (role #1) and the general user (role #2) are the evaluation targets. When null is input to the evaluation target role ID, all the users including the administrator, the general user, and the like are the evaluation targets.

The setting role ID indicates how a role defined by the evaluation target role ID is set when the successor selection rule is satisfied. The selection target IT infrastructure management information ID stores, for example, the IT infrastructure management information ID of the IT infrastructure management information for which a user having the role ID defined by the evaluation target role ID is selected as the administrator. When a plurality of pieces of IT infrastructure management information are selection targets, a plurality of f pieces of IT infrastructure management information #1 and #3 are stored as shown in a selection rule #4.

For example, when administrator role IDs (for example, the roles #1 and #2) are designated in the evaluation target role ID in the successor selection rule management table 35, not only the general user but also a current administrator is subjected to the user evaluation and the ranking. Further, the successor selection rule can be customized freely. As a user who changes the successor selection rule, for example, not only the current administrator of the IT infrastructure management information who changes the successor selection rule, but also a specific higher-ranking person such as a leader, for example, a company manager who manages the IT infrastructure management information is assumed. When the user who changes the successor selection rule other than the administrator is determined in advance, even when a situation where the successor cannot be selected occurs because the successor selection rule is inappropriate after the administrator is absent, a person other than the administrator can change the successor selection rule.

The selection target IT infrastructure management information ID and the evaluation target role ID are used to designate from which user having which role in which IT infrastructure management information the successor is selected. In the selection rule #1, users whose selection target IT infrastructure management information IDs are the IT infrastructure management information #1 are subjected to the evaluation and the ranking, and a user having the first ranking is set as the successor of the IT infrastructure management information #1. In the selection rule #3, the evaluation target role ID is not designated (null in the drawing), and the selection target IT infrastructure management information ID is not designated (null in the drawing). Therefore, the IT infrastructure management information is not limited, and all the users are subjected to the evaluation and the ranking.

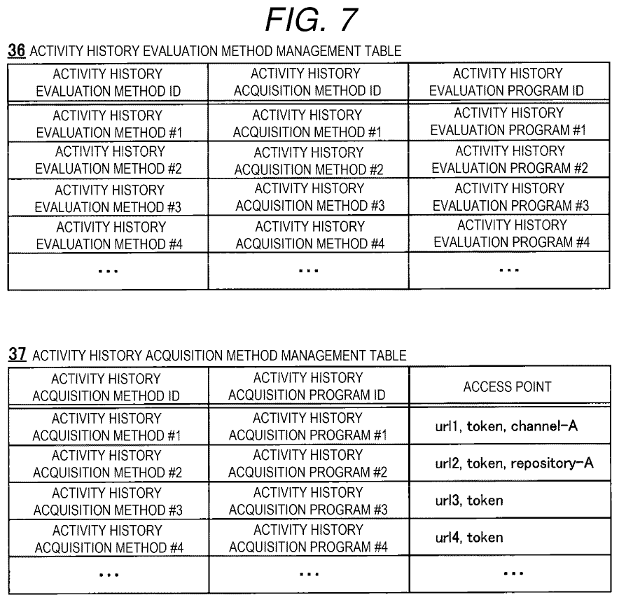

FIG. 7 is a diagram showing configuration examples of the activity history evaluation method management table 36 and the activity history acquisition method management table 37.

The activity history evaluation method management table 36 is a table for managing the activity history evaluation method for evaluating the activity history of the user. The activity history evaluation method management table 36 stores the activity history evaluation method ID, an activity history acquisition method ID, and an activity history evaluation program ID. The activity history evaluation method ID is the same as the activity history evaluation method ID used in the successor selection rule management table 35 described above. The activity history acquisition method ID is associated with the activity history acquisition method management table 37 to be described later.

Activity history evaluation programs #1 to #3 in the activity history evaluation method management table 36 have a function of giving scores to activity history acquired by activity history acquisition programs #1 to #3. For example, the activity history evaluation program #1 has a function of evaluating activity history of a chat service A that is a monitoring target infrastructure of the activity history, and giving scores to the users. The activity history evaluation program #2 has a function of evaluating activity history of a software development platform A, and giving scores to the users. The activity history evaluation program #3 has a function of evaluating activity history of a resource A and giving a score.

On the other hand, the activity history evaluation program #4 in the activity history evaluation method management table 36 has a function of giving a true or false result. For example, when the activity history acquisition program #4 only selects users having five or more years of service, the activity history evaluation program #4 gives True to the users having five or more years of service, and gives False to users having less than five years of service.

The activity history acquisition method management table 37 is a table for managing an activity history acquisition method for acquiring activity history of a user. The activity history acquisition method management table 37 stores the activity history acquisition method ID, an activity history acquisition program ID, and an access point.

The activity history acquisition program ID stores an

ID for identifying a program (an example of an activity history acquisition unit) for acquiring activity history of a user of a resource where the user is active. The activity history acquisition program acquires the activity history for each user for whom a role that is an evaluation target of the activity history (evaluation target role ID) is set, based on the IT infrastructure management information defined in the successor selection rule management table 35. The access point stores address information (URL1 or the like) of an API used by the activity history acquisition program, a token serving as authentication information, a name of a channel for acquiring the activity history, and the like.

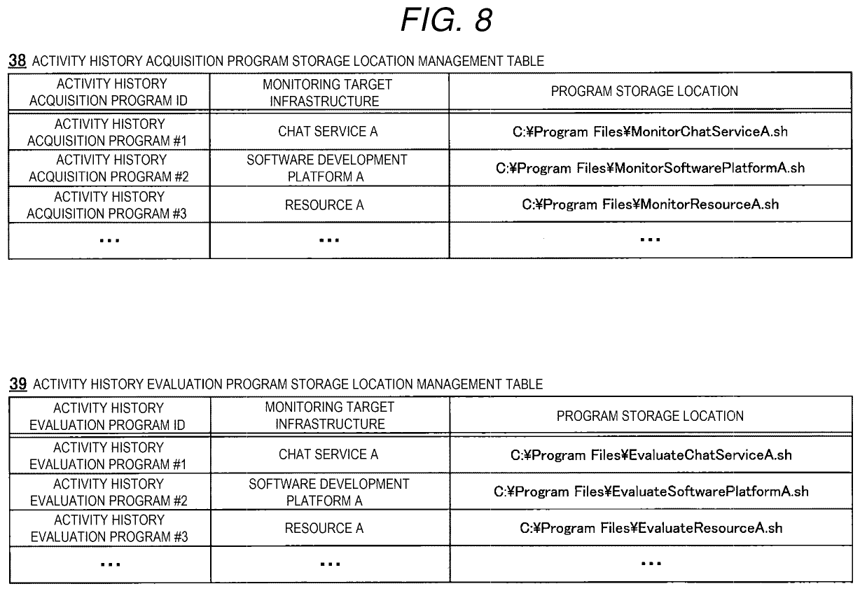

FIG. 8 is a diagram showing configuration examples of the activity history acquisition program storage location management table 38 and the activity history evaluation program storage location management table 39.

The activity history acquisition program storage location management table 38 is a table for managing a storage location of the activity history acquisition program. The activity history acquisition program storage location management table 38 stores the activity history acquisition program ID, the monitoring target infrastructure, and a program storage location. The activity history acquisition program ID is an ID assigned to individually identify the activity history acquisition program. The monitoring target infrastructure stores information on an infrastructure (for example, an infrastructure name) that is a monitoring target for the activity history acquisition program to acquire the activity history of the user. The program storage location stores a storage location of the activity history acquisition program. The activity history monitoring unit 21 can change the activity history acquisition program by adding, deleting, modifying and the like.

The activity history evaluation program storage location management table 39 is a table for managing the storage location of the activity history evaluation program. The activity history evaluation program storage location management table 39 stores the activity history evaluation program ID, the monitoring target infrastructure, and the program storage location. The activity history evaluation program ID is an ID assigned to individually identify the activity history evaluation program. The activity history evaluation program ID stores an ID for identifying the activity history evaluation program (an example of an activity history evaluation unit) that evaluates the activity history of the user of a resource where the user is active.

The monitoring target infrastructure stores information on an infrastructure (for example, a name of the infrastructure) that is a monitoring target for the activity history evaluation program to evaluate the activity history of the user. The program storage location stores a storage location of the activity history evaluation program. The activity history monitoring unit 21 can change the activity history evaluation program by adding, deleting, modifying and the like.

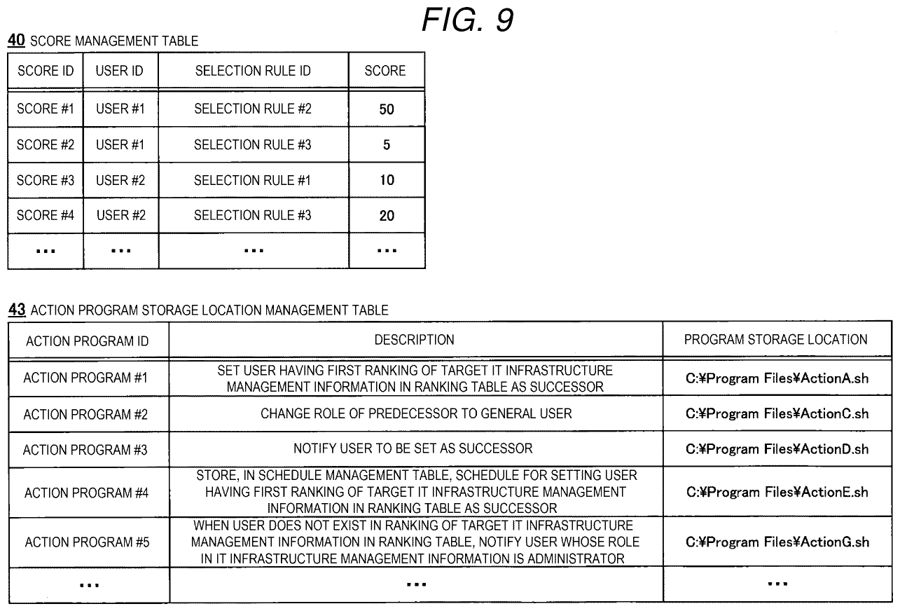

FIG. 9 is a diagram showing configuration examples of the score management table 40 and the action program storage location management table 43.

The score management table 40 is a table for managing, for each user, a score obtained by evaluating the activity history. The score management table 40 stores a score ID, the user ID, the selection rule ID, and a score. The score ID, the user ID, and the selection rule ID are as described above. The score is a value calculated for each user according to the activity history, and is referred to during selection of the successor.

The activity history acquisition program storage unit 41 has a function of storing the activity history acquisition program. Location information of the activity history acquisition program stored in the activity history acquisition program storage unit 41 is shown in the program storage location in the activity history acquisition program storage location management table 38 shown in FIG. 8. Since the activity history acquisition program is a program itself stored in the storage region of the successor setting system 20, a configuration diagram of the activity history acquisition program storage unit 41 is not shown.

The activity history evaluation program storage unit 42 has a function of storing the activity history evaluation program. Location information of the activity history evaluation program stored in the activity history evaluation program storage unit 42 is shown in a program storage location of the activity history evaluation program storage location management table 39 shown in FIG. 8. Since the activity history evaluation program is a program itself stored in the storage region of the successor setting system 20, a configuration diagram of the activity history evaluation program storage unit 42 is not shown.

The action program storage location management table 43 has a function of storing the action program. The action is processing performed on a corresponding user by the evaluation method for the activity history, and the action program is used to execute the action. The action program storage location management table 43 stores the action program ID, description, and the program storage location. The action program ID is an ID assigned to individually identify the action program. The description is an item for describing the action program, but may not be included in the action program storage location management table 43. The program storage location shows the location information of the action program.

In the description items in the action program storage location management table 43, processing written as “notify user to be set as successor” as the action program #3 and “notify user whose role in . . . IT infrastructure management information is administrator” as the action program #5determines processing of the user notification unit 22. In the action program storage location management table 43, an action including at least one of processing of selecting a user having a highest evaluation result as the successor and processing of notifying the user selected as the successor can be changed by adding, deleting, modifying and the like.

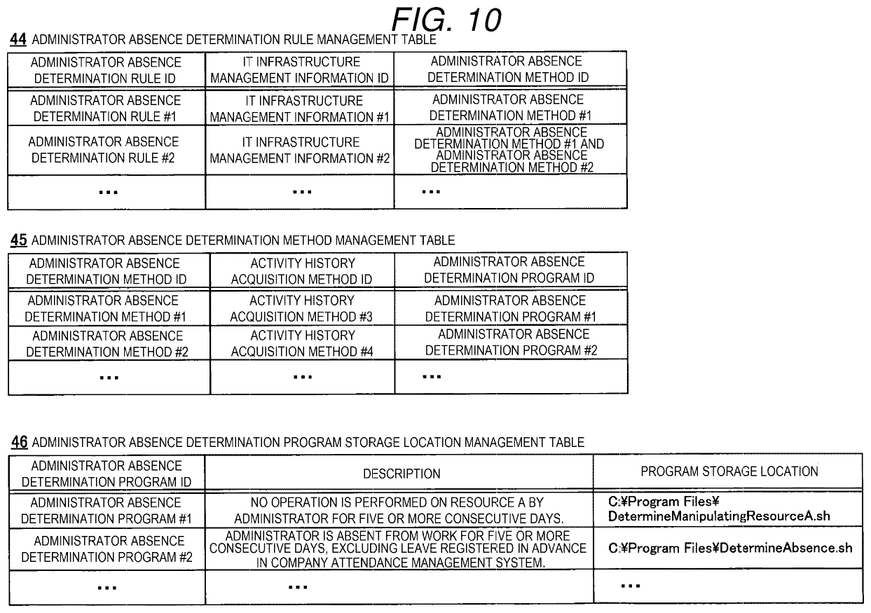

FIG. 10 is a diagram showing configuration examples of the administrator absence determination rule management table 44, the administrator absence determination method management table 45, and the administrator absence determination program storage location management table 46.

The administrator absence determination rule management table 44 is a table for managing the administrator absence determination rule for the activity history processing unit 21a of the activity history monitoring unit 21 shown in FIG. 2 to determine that the administrator is absent. The administrator absence determination rule management table 44 stores an administrator absence determination rule ID, the IT infrastructure management information ID, and an administrator absence determination method ID.

The administrator absence determination rule ID is assigned to identify the administrator absence determination rule set for each piece of IT infrastructure management information. The IT infrastructure management information ID and the administrator absence determination method ID are associated with the administrator absence determination rule ID.

The administrator absence determination method ID stores a single determination method, or a combination of a plurality of determination methods. For example, logical operation symbols (AND, OR, NOT) are used in the combination of the determination methods. A determination program is determined for each administrator absence determination rule by the single determination method or the combination of the plurality of determination methods.

The administrator absence determination method management table 45 is used to refer to the activity history of the administrator in the administrator absence determination. The administrator absence determination method management table 45 stores the administrator absence determination method ID, the activity history acquisition method ID, and an administrator absence determination program ID.

The administrator absence determination method ID is assigned to identify an administrator absence determination method. The activity history acquisition method ID and the administrator absence determination program ID are associated with the administrator absence determination method ID.

The activity history acquisition method ID is assigned to identify an activity history acquisition method. The activity history acquisition method ID is associated with the activity history acquisition method management table 37 shown in FIG. 7.

The administrator absence determination program ID is assigned to identify an administrator absence determination program. The administrator absence determination program ID is associated with the administrator absence determination program storage location management table 46 to be described later.

The administrator determination program absence storage location management table 46 is a table for managing a content of the administrator absence determination program and a storage location of the administrator absence determination program. The administrator absence determination program storage location management table 46 stores the administrator absence determination program ID, description, and the determination program storage location.

The administrator absence determination program ID defines an administrator determination program for determining whether the administtrator is absent.

A content of the administrator determination program is input in the description. For example, when “administrator is absent from work for five or more consecutive days, excluding leave registered in advance in company attendance management system”, it is determined that the administrator is absent. Further, even when the administrator is at work, in a case where an operation is not performed on a specific resource, it may be determined that the administrator is absent. For example, when “no operation is performed on resource A by administrator for five or more consecutive days”, it is determined that the administrator is absent. The description is an item for describing the administrator determination program, but may not be included in the administrator absence determination program storage location management table 46.

The administrator absence determination program storage unit 47 is a storage unit that stores the administrator absence determination program. Since the action program is a program itself stored in the storage region of the successor setting system 20, a configuration diagram of the administrator absence determination program storage unit 47 is not shown.

### Example of Processing of Functional Units

Next, an example of processing of the functional units will be described with reference to FIGS. 11 to 19.

FIG. 11 is a flowchart showing an example of activity history monitoring processing performed by the activity history monitoring unit 21 of the successor setting system 20.

First, the activity history monitoring unit 21 performs loop processing on all records acquired from the successor selection rule management table 35 (S1).

When the loop processing is started, the activity history processing unit 21a of the activity history monitoring unit 21 performs the administrator absence determination processing to determine whether a current administrator is absent (S2). In Step S2, the administrator absence determination processing is performed on a record in the administrator absence determination rule management table 44 having an ID the T infrastructure management information ID of a record in the successor selection rule management table 35. The activity history processing unit 21a determines whether the current administrator is absent based on a result of the administrator absence determination acquired in Step S2 (S3).

When the current administrator is not absent (NO in S3), since it is not necessary to specify and evaluate a user in the record, the processing shifts to Step S7, and loop processing on a next record is performed. On the other hand, when the activity history processing unit 21a determines that the administrator is absent, since it is considered that the current absent administrator cannot continue management of the IT infrastructure management information, the processing shifts to the successor selection processing. Therefore, when the current administrator is absent (YES in S3), the processing shifts to Step S4.

In Step S4, the activity history processing unit 21a performs activity history acquisition and storage processing (S4). Next, processing of specifying, by the user specifying unit 21b, a user to be evaluated by the user evaluation unit 21c (S5) is performed. Next, processing of evaluating, by the user evaluation unit 21c, the user specified by the user specifying unit 21b (S6) is performed. Details of the processing in Steps S4, S5, and S6 will be described later.

After Step S6, when the loop processing on all the records acquired from the successor selection rule management table 35 is not ended (S7), the activity history monitoring unit 21 returns to Step S1, counts up the records, and repeats the processing of Step S2 and thereafter. On the other hand, when the loop processing on all the records is ended (S7), the ranking calculation unit 21e of the activity history monitoring unit 21 performs processing of calculating rankings of the users (S8).

In the ranking calculation processing in Step S8, the ranking calculation unit 21e acquires all the records from the score management table 40 (S8A). Next, the ranking calculation unit 21e calculates rankings of scores having the same “selection rule ID” (S8B). Next, the ranking calculation unit 21e stores the calculated rankings together with the “user ID” and the “selection rule ID” of the records acquired from the score management table 40 in the ranking management table 31 (S8C), and ends the present processing.

FIG. 12 is a flowchart showing an example of the administrator absence determination processing performed by the activity history processing unit 21a. The processing shown in FIG. 12 is a subroutine of the processing in Step S2 in FIG. 11, and is performed by the activity history processing unit 21a.

First, the activity history processing unit 21a acquires, from the administrator absence determination rule management table 44, a record in which the “IT infrastructure management information coincides ID” with the “IT infrastructure management information ID” of the record acquired from the successor selection rule management table 35 (S11).

Next, the activity history processing unit 21a acquires, from the administrator absence determination method management table 45, a record in which the “administrator absence determination method ID” coincides with the “administrator absence determination method ID” of the record acquired from the administrator absence determination rule management table 44 (S12).

Next, the activity history processing unit 21a acquires the “activity history acquisition method ID” and the “administrator absence determination program ID” associated with the “administrator absence determination method ID” of the record acquired from the administrator absence determination method management table 45 (S13).

Next, the activity history processing unit 21a acquires the “activity history acquisition program ID” and the access point associated with the “activity history acquisition method ID” from the activity history acquisition method management table 37 (S14).

Next, the activity history processing unit 21a activates the activity history acquisition program at the program storage location associated with the “activity history acquisition program ID” from the activity history acquisition program storage location management table 38, and acquires the activity history of the administrator from the access point (S15).

Next, the activity history processing unit 21a acquires, from the administrator absence determination rule management table 44, the “administrator absence determination rule ID” and the “administrator absence determination method ID” that are targets of the administrator absence determination and that are associated with the IT infrastructure management information ID (S16).

Next, the activity history processing unit 21a acquires the “activity history acquisition method ID” and the “administrator absence determination program ID” associated with the “administrator absence determination method ID” from the administrator absence determination method management table 45 (S17).

Next, the activity history processing unit 21a activates the administrator absence determination program at the program storage location associated with the “administrator absence determination program ID” from the administrator absence determination program storage location management table 46, and performs the administrator absence determination based on the activity history of the administrator acquired in Step S15 (S18). A result of the administrator absence determination is used in the determination processing in Step S3.

FIG. 13 is a flowchart showing an example of processing of acquiring and storing the activity history by the activity history processing unit 21a. The processing shown in FIG. 13 is a subroutine of the processing in Step S4 in FIG. 11, and is performed by the activity history processing unit 21a.

First, the activity history processing unit 21a acquires, from the activity history evaluation method management table 36, a record in which the “activity history evaluation method ID” coincides with the “activity history evaluation method ID” of the record acquired from the successor selection rule management table 35 (S21).

Next, the activity history processing unit 21a acquires the “activity history acquisition program ID” and the access point associated with the “activity history acquisition method ID” from the activity history acquisition method management table 37 (S22).

Next, the activity history processing unit 21a acquires, from the activity history acquisition program storage location management table 38, all records in each of which the “activity history acquisition program ID” coincides with the “activity history acquisition program ID” of the record acquired from the activity history acquisition method management table 37 (S23).

Next, the activity history processing unit 21a refers to the “program storage location” of the records acquired from the activity history acquisition program storage location management table 38, and acquires the activity history acquisition programs from the activity history acquisition program storage unit 41 (S24).

Next, the activity history processing unit 21a uses the information on the “access point” and the activity history acquisition program of the record acquired from the activity history acquisition method management table 37, acquires activity history data from the monitoring target infrastructure, and stores the activity history data in the activity history storage unit 33 (S25). Thereafter, the processing shifts to the processing in Step S5 in FIG. 11.

FIG. 14 is a flowchart showing an example of processing of specifying, by the user specifying unit 21b, a user to be evaluated by the user evaluation unit 21c. The processing shown in FIG. 14 is a subroutine of the processing in Step S5 in FIG. 11, and is performed by the user specifying unit 21b.

First, the user specifying unit 21b acquires, from the user belonging information management table 15, all records in each of which the IT infrastructure management information ID and the role ID coincide with those set in the “selection target IT infrastructure management information ID” and the “evaluation target role ID” of the record acquired from the successor selection rule management table 35 (S31).

Next, the user specifying unit 21b acquires, from the user information management table 13, all records with the same “user ID” as that of the records acquired from the user belonging information management table 15 (S32). Thereafter, the processing shifts to the processing in Step S6 in FIG. 11.

FIG. 15 is a flowchart showing an example of processing of evaluating, by the user evaluation unit 21c, the user specified by the user specifying unit 21b. The processing shown in FIG. 15 is a subroutine of the processing in Step S6 in FIG. 11, and is performed by the user evaluation unit 21c.

First, the user evaluation unit 21c acquires, from the activity history program evaluation storage location management table 39, all records in each of which the “activity history evaluation program ID” coincides with the “activity history evaluation program ID” of a record acquired from the activity history evaluation method management table 36 (S41).

Next, the user evaluation unit 21c refers to the “program storage location” of the records acquired from the activity history evaluation program storage location management table 39, and acquires the activity history evaluation programs from the activity history evaluation program storage unit 42 (S42).

Next, the user evaluation unit 21c acquires the activity history data from the activity history storage unit 33, applies the activity history data and the “mail address” of the record acquired from the user information management table 13 to the activity history evaluation program, and calculates a score for each user based on a calculation equation defined in the activity history evaluation program of the record acquired from the activity history evaluation method management table 36 (S43). The mail address is used for identification of each user.

Next, the user evaluation unit 21c stores the “user ID” of a user, the “selection rule ID” of a record acquired from the successor selection rule management table, and a calculated score in the score management table for each user (S44). Thereafter, the processing shifts to the processing in Step S7 in FIG. 11.

FIG. 16 is a flowchart showing an example of processing of executing the action program by the action program execution unit 21d. The processing shown in FIG. 16 is periodically executed by the action program execution unit 21d. Alternatively, the action program execution unit 21d may start the processing when a user manually instructs execution.

First, the action program execution unit 21d acquires all records from the successor selection rule management table 35 (S51).

Next, the action program execution unit 21d performs the loop processing on all the records acquired from the successor selection rule management table 35 (S52). In the loop processing, the action program execution unit 21d acquires, from the action program storage location management table 43, all records in each of which the “action program ID” coincides with the “action program ID” of an acquired record (S53).

Next, the action program execution unit 21d acquires all action programs from the “program storage location” of all the records acquired from the action program storage location management table 43 (S54).

Next, the action program execution unit 21d executes all the acquired action programs (S55). In Step S55, the action programs defined by the action program IDs in the action program storage location management table 43 shown in FIG. 9 and read from the program storage locations are executed. For example, the action program #3 is an action program that “notify user to be set as successor”, and the user notification unit 22 shown in FIG. 2 operates. Similarly, the user notification unit 22 also operates in the action program #5, that is, an action program that “notify user . . . ”

When the loop processing on all the records acquired from the successor selection rule management table 35 is ended (S56), the action program execution unit 21d ends the monitoring processing on the activity history.

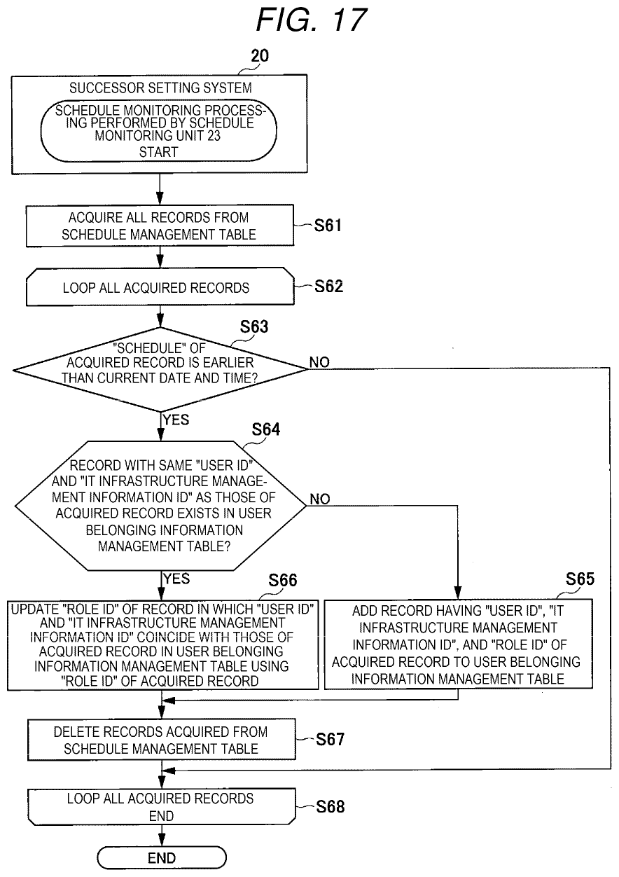

FIG. 17 is a flowchart showing an example of processing of monitoring a schedule of the successor selection and changing a role of a user by the schedule monitoring unit 23. The processing shown in FIG. 17 is periodically executed by the schedule monitoring unit 23. Alternatively, the schedule monitoring unit 23 may start the processing when a user manually instructs execution.

First, the schedule monitoring unit 23 acquires all records from the schedule management table 32 (S61).

Next, the schedule monitoring unit 23 performs the loop processing on all the records acquired from the schedule management table 32 (S62). In the loop processing, the schedule monitoring unit 23 determines whether a “schedule” of an acquired record is earlier than current date and time (S63). When the “schedule” of the acquired record is not earlier than the current date and time (NO in S63), the schedule monitoring unit 23 shifts to Step S68. A record whose “schedule” is later than the current date and time remains, and is used when the schedule monitoring processing is performed on another date and time. Since the schedule monitoring unit 23 periodically executes the schedule monitoring processing, the “schedule” remains until the “schedule” exceeds the current date and time.

On the other hand, when the “schedule” of the acquired record is earlier than the current date and time (YES in S63), the schedule monitoring unit 23 determines whether a record with the same “user ID” and “IT infrastructure management information ID” as those of the acquired record exists in the user belonging information management table 15 (S64). When the corresponding record does not exist in the user belonging information management table 15 (NO in S64), the schedule monitoring unit 23 adds a record having the “user ID”, the “IT infrastructure management information ID”, and the “role ID” of the acquired record to the user belonging information management table 15 (S65).

On the other hand, when the coinciding record exists in the user belonging information management table 15 (YES in S64), the schedule monitoring unit 23 updates the “role ID” of the record in which the “user ID” and the “IT infrastructure management information ID” coincide with those of the acquired record in the user belonging information management table 15 using the “role ID” of the acquired record (S66).

After Step S65 or S66, the schedule monitoring unit 23 deletes the records acquired from the schedule management table 32 (S67). After Step S67 or NO determination in Step S63, when the loop processing on all the records acquired from the schedule management table 32 is ended (S68), the schedule monitoring unit 23 ends the present processing.

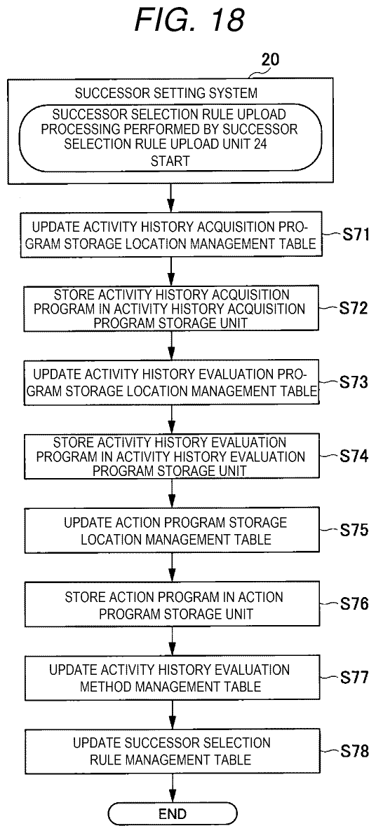

FIG. 18 is a flowchart showing an example of the successor selection rule upload processing. When a user manually instructs execution, the successor selection rule upload unit 24 executes the processing shown in FIG. 18.

First, the successor selection rule upload unit 24 updates the activity history acquisition program storage location management table 38 (S71). With the update processing, the existing items “monitoring target infrastructure” and “program storage location” are updated or new items are added. Next, the successor selection rule upload unit 24 stores the activity history acquisition program in the activity history acquisition program storage unit 41 (S72). For example, when a new activity history acquisition program is added, a program ID, a monitoring target infrastructure, and a program storage location of the added program are stored in the activity history acquisition program storage location management table 38. Further, when an existing activity history acquisition program is renamed, for example, in the activity history acquisition program #1, a program name stored in a program storage location is renamed. When the successor selection rule upload unit 24 is executed, it is possible to select whether to update or add the activity history acquisition program storage location management table 38.

Next, the successor selection rule upload unit 24 updates the activity history evaluation program storage location management table 39 (S73). Next, the successor selection rule upload unit 24 stores the activity history evaluation program in the activity history evaluation program storage unit 42 (S74). Since the update processing of the activity history evaluation program storage location management table 39 is similar to the processing of the activity history acquisition program described in Step S71, detailed description thereof will be omitted. Further, when the successor selection rule upload unit 24 is executed, it is possible to select whether to update or add the activity history evaluation program storage location management table 39.

Next, the successor selection rule upload unit 24 updates the action program storage location management table 43 (S75). Next, the successor selection rule upload unit 24 stores the action program in the action program storage unit 34 (S76).

Next, the successor selection rule upload unit 24 updates the activity history evaluation method management table 36 (S77). Next, the successor selection rule upload unit 24 updates the successor selection rule management table 35 (S78), and ends the present processing.

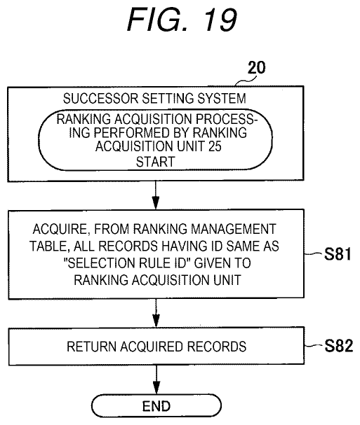

FIG. 19 is a flowchart showing an example of the ranking acquisition processing. When a user manually instructs execution, the ranking acquisition unit 25 executes the processing shown in FIG. 19.

First, the ranking acquisition unit 25 acquires, from the ranking management table 31, all records having ID the same as the “selection rule ID” given to the ranking acquisition unit 25 (S81).

Next, the ranking acquisition unit 25 returns the acquired records to a system or a device that issues the ranking acquisition instruction (S82), and ends the present processing.

### Hardware Configuration Example of Computer

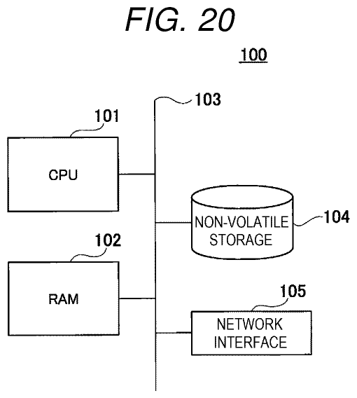

Here, a hardware configuration of a computer 100 that constitutes the public cloud server 1 will be described. FIG. 20 is a block diagram showing a hardware configuration example of the computer 100. The computer 100 is an example of hardware used as a computer that can operate as the public cloud server 1 according to the present embodiment. The public cloud server 1 according to the present embodiment implements a successor setting method performed by the functional blocks shown in FIG. 2 in cooperation with one another when the computer 100 executes a program.

The computer 100 includes a central processing unit (CPU) 101 and a random access memory (RAM) 102 connected to a bus 103. The computer 100 further includes a non-volatile storage 104 and a network interface 105.

The CPU 101 reads, from the non-volatile storage 104, a program code of software that implements each function according to the present embodiment, loads the program code in the RAM 102, and executes the program code. Variables, parameters, and the like generated during arithmetic processing of the CPU 101 are temporarily written into the RAM 102, and these variables, parameters, and the like are appropriately read by the CPU 101.

As the non-volatile storage 104, for example, a hard disk drive (HDD), a solid state drive (SSD), a flexible disc, an optical disk, a magneto-optical disk, a CD-ROM, a CD-R, a magnetic tape, or a non-volatile memory is used. In addition to an operating system (OS) and various parameters, a program for causing the computer 100 to function is stored in the non-volatile storage 104. The non-volatile storage 104 stores programs, data, and the like necessary for the CPU 101 to operate, and is used as an example of a non-transitory storage medium that can be read by a computer that stores a program executed by the computer 100.

For example, a network interface card (NIC) or the like is used in the network interface 105, and various pieces of data can be transmitted and received between devices via a local area network (LAN) connected to a terminal of the NIC, a dedicated line, or the like.

In the successor setting system 20 according to the embodiment described above, when the administrator of the IT infrastructure management information is absent, the successor is automatically selected, and the successor takes over management of the IT infrastructure management information, whereby it is possible to continue use of the IT infrastructure management information. Since the selection of the successor is performed according to the preset administrator selection rule, there is no need to set the successor in advance.

In the successor setting system 20, before the administrator of the IT management infrastructure information is absent, the users of the IT infrastructure management information are scored in advance. In this way, in the successor setting system 20, even when the administrator of the IT infrastructure management information is absent, the successor can be selected based on an evaluation result obtained by evaluating the users by using the activity history of the resource and the infrastructure under management of the IT infrastructure management information such as a storage. Therefore, even when the successor is not set in advance, it is possible to select a successor who takes over the management of the IT infrastructure management information from the administrator.

The successor setting 20 system can grant the administrator authority to an appropriate user based on a score. Further, the user is active in a calculation period of scoring, and it is easy to select an appropriate user as the successor. Further, since the selection of the successor is automatically performed, as compared with an operation of selecting the successor manually in the related art, it is possible to reduce a selection cost of the successor.

The administrator selection rule can be customized freely. For example, the successor selection rule can be customized according to organization operation of the IT infrastructure management information. Therefore, it is possible to expect an increase in possibility of selecting the successor, and improvement in permanence of the administrator selection rule.

Since the successor selection rule can be permanently applied regardless of a change in an organizational structure or a variation in a user workload, it is possible to reduce the selection cost of the successor. For example, a user who is no longer involved in the IT infrastructure management information due to the change in the organizational structure is not selected as the successor.

The successor setting system 20 can provide a mechanism for defining an evaluation method as an expression combining a plurality of monitoring metrics desired by a user. The monitoring metric is an index defined by the activity history evaluation method management table 36, and indicates the activity history is acquired from which resource and how the activity history is evaluated. The successor setting system 20 can provide a mechanism for using any collection program desired by a user by using a monitoring metric that can be customized by the user.

The resource may be, for example, a physically existing storage installed in a company, or a physically non-existing storage running in a public cloud. Further, the resource may be a hybrid cloud storage obtained by combining the physically existing storage and the physically non-existing storage. Regardless of which resource, when an administrator is determined, the successor setting system 20 can automatically select the successor based on the activity history of the user and the successor selection rule.

### Modifications

The processing shown in FIG. 11 may be executed at any timing. For example, the processing may be executed earlier than a schedule stored in the schedule management table 32 shown in FIG. 5. Further, the processing shown in FIG. 11 and the subsequent drawings may be replaced or executed freely.

The ranking calculation processing (S7) in FIG. 11 is executed at a timing at which the successor selection is necessary, whereby the ranking may be calculated on demand. For example, after it is determined in Step S2 in FIG. 11 that the current administrator is not absent, the ranking calculation processing (S7) may be executed when it is determined that it is the timing at which the successor selection is necessary.

Similarly, since it is necessary to select the successor, when it is a timing to acquire the ranking, the processing of acquiring the ranking by the ranking acquisition unit 25 shown in FIG. 19 may be executed.

The invention is not limited to the embodiment described above, and it goes without saying that various other applications and modifications can be made without departing from the gist of the invention as described in the claims.

For example, in the embodiment described above, the configuration of the system is described in detail and specifically in order to describe the invention in an easy-to-understand manner, and the system is not necessarily limited to including all the configurations described. Further, it is also possible to add, delete, or replace a part of the configuration of the present embodiment with another configuration.

Further, control lines and information lines are those considered to be necessary for description, and not all the control lines and information lines are necessarily shown in the product. Actually, it may be considered that almost all the configurations are connected to one another.

What is claimed is:

1. A successor setting system comprising:
a successor selection rule management table in which a successor selection rule is managed, the successor selection rule being used to select a successor of an administrator of infrastructure management information by which users who operate a resource are managed when the administrator is unable to continue managing the infrastructure management information; and
an activity history monitoring unit configured to monitor activity history of the users in the resource, apply an evaluation result obtained by evaluating the activity history for each user to the successor selection rule to select the user who is to be the successor, and set the selected user as the successor.

2. The successor setting system according to claim 1, wherein
in the successor selection rule management table, an evaluation method for the activity history, and processing performed on the corresponding user by the evaluation method for the activity history are defined for each user.

3. The successor setting system according to claim 2, wherein
in the infrastructure management information, in addition to the user who operates the resource, the resource and an authority for the user to operate the resource are managed, and
in the successor selection rule management table, the evaluation method for the activity history and the processing performed on the corresponding user by the evaluation method for the activity history are defined for each piece of the infrastructure management information and for each role by which the authority for the user to operate the resource is defined.

4. The successor setting system according to claim 3, wherein
the activity history monitoring unit is configured to associate the infrastructure management information with the evaluation method for the activity history, and to change an activity history acquisition unit configured to acquire the activity history of the user in the resource where the user is active.

5. The successor setting system according to claim 4, wherein
the activity history acquisition unit acquires the activity history for each user for whom the role that is an evaluation target of the activity history is set based on the infrastructure management information defined in the successor selection rule.

6. The successor setting system according to claim 5, wherein
the activity history monitoring unit is configured to change an activity history evaluation unit defined in the evaluation method for the activity history and configured to evaluate the activity history of the resource where the user is active.

7. The successor setting system according to claim 5, wherein
an action including at least one of processing of selecting the user having the highest evaluation result as the successor and processing of notifying the user selected as the successor as the processing performed on the corresponding user by the evaluation method for the activity history is changeable.

8. The successor setting system according to claim 6, wherein
the activity history monitoring unit includes a ranking calculation unit configured to calculate a ranking of the evaluation result evaluated by the activity history evaluation unit for the activity history acquired by the activity history acquisition unit.

9. The successor setting system according to claim 8, wherein
a plurality of the evaluation results are calculated by a combination of four arithmetic operation symbols or a logical operation symbol defined in the successor selection rule.

10. The successor setting system according to claim 8, further comprising:
a ranking acquisition unit configured to acquire a result of the ranking, wherein
the ranking acquisition unit outputs the result of the ranking to another system or device that issues an instruction to acquire the result of the ranking.

11. The successor setting system according to claim 10, further comprising:
a schedule monitoring unit configured to monitor whether current date and time exceed date and time defined by a schedule for selecting the successor, wherein
when the schedule monitoring unit is notified that the current date and time exceed the date and time defined by the schedule for selecting the successor, the activity history monitoring unit executes an action on the user, and selects the user whose result of the ranking acquired by the ranking acquisition unit is high as the successor.

12. The successor setting system according to claim 3, wherein
when the activity history monitoring unit determines that the administrator is absent based on an administrator absence determination rule, the administrator is defined as unable to continue managing the infrastructure management information.

13. A successor setting method comprising:
a step of monitoring activity history of users in a resource and evaluating the activity history for each user; and
a step of, when an administrator of infrastructure management information by which the users who operate the resource are managed is unable to continue managing the infrastructure management information, applying an evaluation result of the activity history to a successor selection rule used to select a successor of the administrator, selecting the user to be the successor, and setting the selected user as the successor.

14. A program causing a computer to execute:
a step of monitoring activity history of users in a resource and evaluating the activity history for each user; and
a step of, when an administrator of infrastructure management information by which the users who operate the resource are managed is unable to continue managing the infrastructure management information, applying an evaluation result of the activity history to a successor selection rule used to select a successor of the administrator, selecting the user to be the successor, and setting the selected user as the successor.
